(19) United States
(12) Patent Application Publication
(10) Pub. No.: US 2004/0182656 A1
(43) Pub. Date: Sep. 23, 2004

(54) Vehicle slip stop device

(75) Inventors: Moriharu Sakai, Aichi (JP); Takashi Watanabe, Aichi (JP); Shoichi Masaki, Aichi (JP)

Correspondence Address: BURNS, DOANE, SWECKER & MATHIS, L.L.P., P.O. Box 1404, Alexandria, VA, 22313-1404, US

(73) Assignee: ADVICS CO., LTD.

(21) Appl. No.: 10/673,150

(22) Filed: Sep. 30, 2003

(30) Foreign Application Priority Data
Oct. 4, 2002 (JP) 2002-292020

(51) Int. Cl. B60T 3/00

(52) U.S. Cl. 188/32

(57) ABSTRACT

A slip stop device is proposed which can scatter a slip stop material between each tire and the road surface even when the steering wheel is turned or during “nose dive”. The slip stop device includes a nozzle through which the slip stop material is discharged and a container from which the slip stop material is supplied to the nozzle. The nozzle and the container are mounted on an axle carrier supporting a wheel with the nozzle oriented such that the slip stop material is scattered therethrough into a space between the tire and the road surface. The nozzle and the container are provided sufficiently close to each other so that the slip stop material can be instantly scattered through the nozzle when the valves are opened with practically no time lag.

### BACKGROUND OF THE INVENTION

This invention relates to a device for preventing slippage of vehicle wheels at start or while the vehicle is traveling.

On a road surface that is low in friction coefficient such as a frozen road, the grip force of vehicle tires is low, so that vehicle wheels are more likely to slip at start or while the vehicle is traveling. Slippage of tires markedly prolongs the travel distance of the vehicle until the vehicle comes to a complete stop after the brakes have been applied. This increases the possibility of the vehicle colliding against obstacles. Moreover, since on such a road surface the degree of slip tends to be different from one vehicle wheel to another, the stability of the vehicle may be lost to such an extent that the vehicle may get off the intended lane. This can lead to a grave accident such as collision.

Modern vehicles are equipped with means for ensuring stable travel, such as antilock brake systems (ABS), which separately control the braking forces applied to the individual vehicle wheels based on information about the degree of slip detected for the respective vehicle wheels, and vehicle stability control (VSC) systems, which detect the steering tendency of the vehicle based on information from a yaw rate sensor and/or a lateral acceleration sensor and control the engine output and/or the braking forces applied to the individual wheels. But these devices are effective only if the grip of the vehicle tires remains to some extent.

In order to prevent the wheels from slipping on a low friction coefficient road surface, slip-stop devices are proposed (in JP patent publications 4-38204, 7-309101, 8-25905 and 8-300903) which are adapted to scatter a slip-stop material such as sand or ice particles into between the tire and the road surface.

A slip-stop device of a type that scatters solid particles at normal temperature such as sand has a container for storing such particles. A slip-stop device of a type that scatters ice particles has a water tank for storing water as a source of ice particles. If the slip-stop material is forcibly scattered under gas pressure, the slip-stop device has injection nozzles through which the slip-stop material is scattered. If it is simply let to drop, discharge ports are provided at the bottom of the material container.

Judging from the descriptions and drawings of the abovementioned publications, the slip-stop devices disclosed in these publications have nozzles or discharge ports through which the slip-stop material is to be scattered mounted on the chassis or the body of the vehicle through brackets.

When the driver turns the steering wheel, or if “nose-dive” occurs due to hard braking, the relative orientation of the the chassis or the body of the vehicle and the vehicle wheels changes. Thus, the orientation of the nozzles or discharge ports of the slip stop device also changes relative to the wheels. This makes it difficult to scatter the slip stop material right in front of the tires of each vehicle wheel.

The slip stop device of JP 4-38204 has a discharge port extending over the entire width of the vehicle to scatter the slip stop material on a road surface in an area corresponding to the width of the vehicle. Of course, in this arrangement, an extremely large amount of slip-stop material is needed, and most of the scattered slip-stop material is not used for the intended purpose. Thus, this arrangement is not only uneconomical but also impractical.

An object of the invention is to provide a slip stop device which can scatter a slip stop material between each tire and a road surface even when the steering wheel is turned or during “nose dive”.

### SUMMARY OF THE INVENTION

According to this invention, there is provided a vehicle slip stop device mounted on a vehicle for scattering slip stop material to a space between vehicle tyre and the road surface, said slip stop device comprising a discharge port through which a slip stop material is scattered, said discharge port being mounted on an axle support member.

With this arrangement, it is possible to scatter a slip stop material to a space between each tire and a road surface even when the steering wheel is turned or during “nose dive”. The supply source is also mounted on the axle support member so as to be sufficiently close to the discharge port so that the slip stop material can be instantly scattered through the nozzle when the valves are opened with practically no-time lag.

### BRIEF DESCRIPTION OF THE DRAWINGS

Other features and objects of the present invention will become apparent from the following description made with reference to the accompanying drawings, in which:

FIG. 1 schematically shows a vehicle on which is mounted a slip stop device embodying the present invention;

FIG. 2 is a schematic view of the slip stop device; and

FIG. 3 is a sectional plan view of the vehicle of FIG. 1, showing its front wheel tire support structure, and part of the slip stop device mounted on the front wheel tyre support structure.

### DETAILED DESCRIPTION OF THE PREFERRED EMBODIMENT

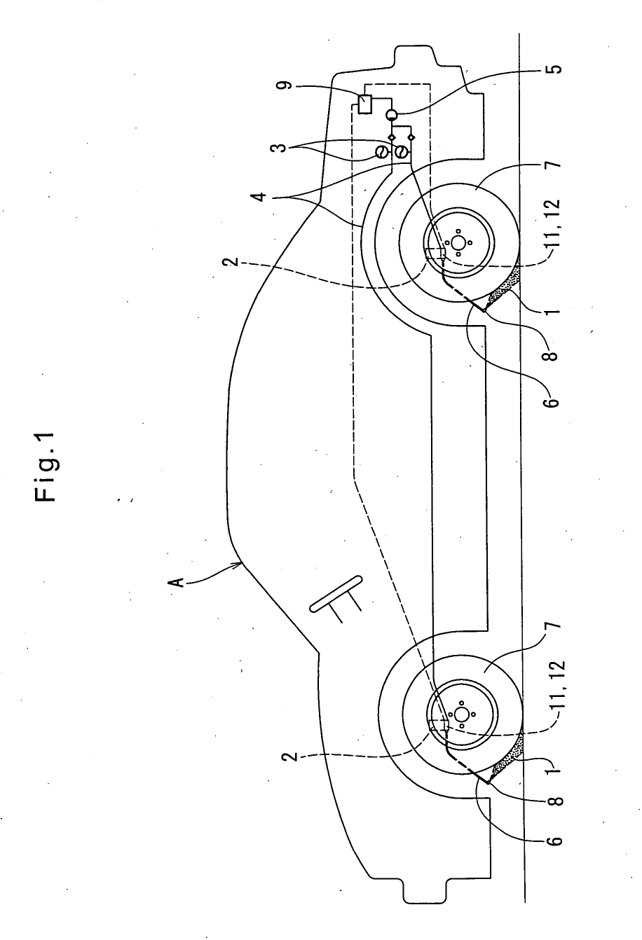

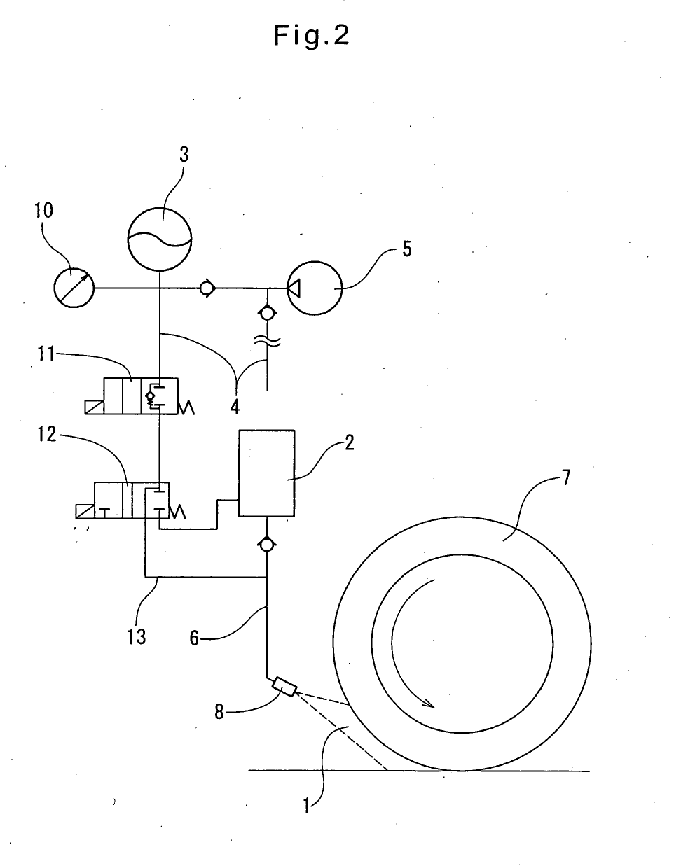

The embodiment of FIGS. 1-3 is described below. First referring to FIGS. 1 and 2, the slip stop device, which is mounted on a vehicle A, comprises material containers 2 in which is stored a slip stop material 1 such as sand, a pump 5 connected to the containers 2 through lines 4, accumulators 3 provided in the lines 4 for accumulating gas pressure produced by the pump 5, nozzles 8 connected to the respective containers 2 through lines 6 for scattering the slip stop material 1 to a space between the tires 7 and the road surface under the gas pressure produced by the pump 5.

In each line 4, a pressure sensor 10 for sensing the pressure in the accumulator 3 and two solenoid valves 11 and 12 are provided. A controller 9 calculates the amount of slippage of each vehicle wheel based on information from wheel speed sensors and a vehicle speed sensor (not shown). If the controller 9 determines that the amount of slippage of any wheel has exceeded a predetermined threshold, it will open the corresponding solenoid valves 11 and 12 to scatter the slip stop material 1 in the container or containers 2 through the corresponding nozzle or nozzles 8.

The controller 9 also monitors the output of the pressure sensors 10, and selectively activates the pump 5 to accumulate a predetermined pressure in the accumulators 3. A bypass 13 extends between the solenoid valve 12 and the nozzle 8 so that only pressurized gas can be supplied through the nozzle 8. If the gas is smoothly blown out of the nozzle, one can confirm that the nozzle is not clogged and the slip-stop device will operate normally.

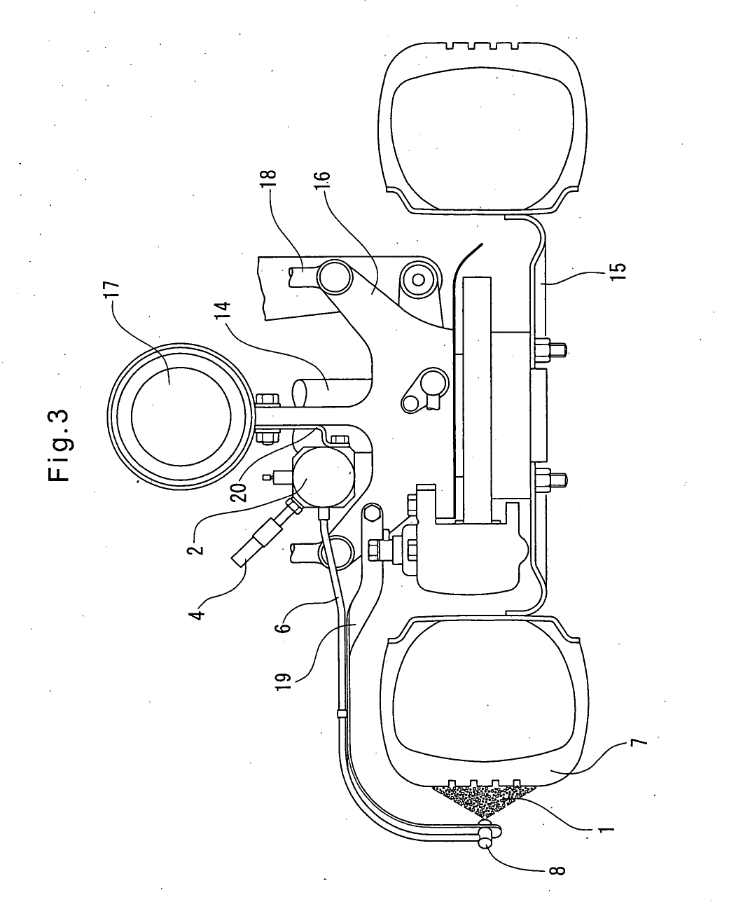

FIG. 3 shows a front wheel tire support structure for a front-wheel drive, four-wheel steering type vehicle. It shows how a material container 2 and a nozzle 8 are mounted. A wheel 15, which carries the tire 7 and is connected to a drive shaft 14, is supported on a suspension 17 through an axle carrier 16, which is coupled to a steering mechanism (not shown) through a tie rod 18. The rear wheel side support structures are substantially identical to the front wheel side support structures except that they have no drive shafts 14.

The nozzle 8 is mounted on the axle carrier 16 (which is an axle support member) through a stay 19 so as to be directed at the center of the tire tread but spaced therefrom. Since the nozzle 8 is mounted on the axle carrier 16, its orientation relative to the tire 7 remains unchanged even when the steering angle changes or if nose dive occurs. The slip stop material can thus be scattered at the intended area between the tire tread and the road surface.

The container 2, too, is mounted on the axle carrier 16 through a bracket 20 and connected to the nozzle 8 through a short hose 6 so that the slip stop material 1 in the container will be supplied to the nozzle 8 through the hose 6. The solenoid valves 11 and 12 are provided at the downstream end of the hose 4 and fixed to the bottom of the container 2. Thus, the moment the valves 11 and 12 are opened, the material 1 in the container 2 will be instantly pushed out of the container 2 under gas pressure and scattered through the nozzle 8 with practically no time-lag.

In the embodiment, the nozzle, which is a material discharge port, and the container, which is a material supply source, are mounted on the axle carrier. But the nozzle may be mounted on any other portion of the vehicle if the orientation relative to the tyre remains unchanged. It may be mounted on any other axle support member. Also, the container may be mounted on other axle support member, provided it is close to the nozzle.

With this arrangement, the orientation of the nozzle relative to the tire is unchanged even when the steering wheel is turned or during nose dive. The slip stop material can thus be scattered at the intended area between the tire tread and the road surface.

Since the container, too, is mounted on an axle support member, the container and the nozzle can be provided close to each other, so that the slip stop material can be scattered instantly when the controller opens the valve with practically no time lag.

What is claimed is:

1. A vehicle slip stop device mounted on a vehicle for scattering slip stop material to a space between vehicle tire and the road surface, said slip stop device comprising a discharge port through which a slip stop material is scattered, said discharge port being mounted on an axle support member.

2. The slip stop device claimed in claim 1 further comprising a supply source for supplying the slip stop material to said discharge port, said supply source being mounted on said axle support member.
